(19) United States
(12) Patent Application Publication
(10) Pub. No.: US 2020/0408516 A1
(43) Pub. Date: Dec. 31, 2020

(54) Method For Modeling and Analyzing Generalized Microscopic Stress Concentration Phenomenon on Machined Surface

(71) Applicant: Beihang University, Beijing (CN)

(72) Inventors: Xun LI, Beijing (CN); Zhiyuan GUO, Beijing (CN); Shenliang YANG, Beijing (CN)

(73) Assignee: Beihang University, Beijing (CN)

(21) Appl. No.: 16/868,549

(22) Filed: May 7, 2020

(30) Foreign Application Priority Data
Jun. 28, 2019 (CN) 201910579872.0

(51) Int. Cl. G01B 21/32

(52) U.S. Cl. CPC G01B 21/32

(57) ABSTRACT

A method is provided for modeling and analyzing a generalized microscopic stress concentration phenomenon on a machined surface. The modeling method includes: obtaining a true stress-strain curve of a matrix material structure of a specimen; obtaining a micro-topography curve of a machined surface of a machined specimen; processing a plastic deformation layer of a surface of the machined specimen to obtain a plurality of sub-plastic deformation layers; according to the true stress-strain curve of the specimen and the plurality of sub-plastic deformation layers, obtaining a stress-strain curve of each sub-plastic deformation layer; according to the micro-topography curve of the machined surface, attribute information of the matrix material structure, the stress-strain curve of each sub-plastic deformation layer and a corresponding thickness of each sub-plastic deformation layer, constructing a two-dimensional layered finite element analysis model for analyzing the generalized microscopic stress concentration phenomenon of the machined surface of a specimen.

### CROSS REFERENCE TO THE RELATED APPLICATIONS

This application is based upon and claims priority to Chinese Patent Application No. 201910579872.0, filed on Jun. 28, 2019, the entire contents of which are incorporated herein by reference.

### TECHNICAL FIELD

The present invention belongs to the field of machined surface integrity, and more particularly, to a method for modeling and analyzing the generalized microscopic stress concentration phenomenon on a machined surface.

### BACKGROUND

For a given material, the machined surface integrity is a major factor in the fatigue performance of the specimen. Specifically, the micro-morphology of the machined surface affects the fatigue performance of the specimen by changing the microscopic stress concentration factor of the surface, which is referred to as the geometric microscopic stress concentration phenomenon of the surface.

The geometric microscopic stress concentration phenomenon is the theory of study relating to how the microscopic geometric morphology of the machined surface affects the fatigue performance of the specimen. The theory of study is deficient, however, in the manner in which the machined surface integrity affects the fatigue performance of the specimen. The main reason is that in the process of turning, milling, grinding and even surface strengthening, the plastic deformation with a high strain rate causes the properties of the surface material to change significantly. The microscopic stress concentration of the surface is caused by the surface roughness, as well as the severe plastic deformation strengthening (without considering the factors of surface microcracks) of the machined surface, which is referred to as the strengthening stress concentration phenomenon.

The strengthening stress concentration phenomenon will also significantly affect the fatigue performance of the specimen, which has long been neglected by researchers. FIG. 1 shows the basic principle of the strengthening stress concentration phenomenon. After the specimen is machined, the surface material in the plastic deformation zone must be strengthened by the plastic deformation, which causes the mechanical property curve of the surface material to change from the OacbB curve to the Oab′B′ curve in FIG. 1, but does not change the mechanical property curve of the matrix material of the specimen. When the entire specimen is subjected to the external fatigue load σ₀, the strain of the surface layer material is equal to that of the matrix material; and when the strain is in the interval of (ε₀, ε_{b}′), the actual load σ₁ loading on the surface layer material must be greater than the actual load σ₂ loading on the matrix material. Therefore, the material with the typical plastic strengthening characteristic will form the strengthening stress concentration phenomenon on the surface of the specimen within a certain range of external applied load.

### SUMMARY

### (1) Technical Problems to be Solved

In order to solve the deficiency of the prior art in researching the geometric microscopic stress concentration phenomenon, the first aspect of the present invention provides a method for modeling the generalized microscopic stress concentration phenomenon on the machined surface, and the second aspect of the present invention provides a method for analyzing the generalized microscopic stress concentration phenomenon on the machined surface.

### (2) Technical Solution

In order to achieve the above objectives, the present invention provides a method for modeling a generalized microscopic stress concentration phenomenon on a machined surface, including the following steps:
S1: obtaining a true stress-strain curve of a matrix material structure of a specimen to be machined;
S2: obtaining a micro-topography curve of a machined surface of a machined specimen, wherein the machined specimen is obtained after the specimen is machined in advance;
S3: processing a plastic deformation layer of a surface of the machined specimen by using a layering criterion of a plastic deformation layer of the machined surface to obtain a plurality of sub-plastic deformation layers;
S4: according to the true stress-strain curve of the specimen to be machined and the plurality of sub-plastic deformation layers, obtaining a stress-strain curve of each sub-plastic deformation layer; and
S5: according to the micro-topography curve of the machined surface of the machined specimen, attribute information of the matrix material structure, the stress-strain curve of each sub-plastic deformation layer and a corresponding thickness of each sub-plastic deformation layer, constructing a two-dimensional layered finite element analysis model for analyzing the machined surface of the machined specimen.

Optionally, before step S3, an identification method of the plastic deformation layer is adopted to identify the plastic deformation layer of the surface of the machined specimen, wherein the identification method includes the following steps:
observing a fibrous deformation and a direction of grains in a cross-section structure of the machined specimen, and determining a total thickness of a plastic fiber-like structure produced by a material metallographic structure of the machined specimen in a direction perpendicular to the machined surface according to the fibrous deformation and the direction to determine the plastic deformation layer of the machined surface; and
dividing the plastic deformation layer of the machined surface into a plurality of sub-plastic deformation layers according to an angle θ between the fibrous direction of the grains in the material structure and a normal direction of the machined surface.

Optionally, the plurality of sub-plastic deformation layers include: a zeroth sub-plastic deformation layer, a first sub-plastic deformation layer, a second sub-plastic deformation layer, a third sub-plastic deformation layer and a fourth sub-plastic deformation layer; and
wherein, an angle θ of the zeroth sub-plastic deformation layer is equal to 0 degrees, an angle θ of the first sub-plastic deformation layer is greater than 0 degrees and less than or equal to 30 degrees, an angle θ of the second sub-plastic deformation layer is greater than 30 degrees and less than or equal to 60 degrees, an angle θ of the third sub-plastic deformation layer is greater than 60 degrees and less than 75 degrees, and an angle θ of the fourth sub-plastic deformation layer is greater than 75 degrees and less than or equal to 90 degrees.

Optionally, in step S4, the stress-strain curve of each sub-plastic deformation layer is obtained, wherein
a stress-strain curve of the zeroth sub-plastic deformation layer is the same as the true stress-strain curve of the matrix material structure;
based on a thicknesses ratio of the other sub-plastic deformation layers other than the zeroth sub-plastic deformation layer, a plastic deformation strengthening portion of the true stress-strain curve is segmented in equal proportion on a coordinate axis of a strain variable to obtain a stress-strain curve of the first sub-plastic deformation layer, a stress-strain curve of the second sub-plastic deformation layer, a stress-strain curve of the third sub-plastic deformation layer and a stress-strain curve of the fourth sub-plastic deformation layer, respectively; wherein,
the stress-strain curve of the first sub-plastic deformation layer is the stress-strain curve of the zeroth sub-plastic deformation layer minus a yield portion of the matrix material structure;
the stress-strain curve of the second sub-plastic deformation layer is the stress-strain curve of the first sub-plastic deformation layer minus a strengthening curve portion corresponding to a thickness of the first sub-plastic deformation layer;
the stress-strain curve of the third sub-plastic deformation layer is the stress-strain curve of the second sub-plastic deformation layer minus a strengthening curve portion corresponding to a thickness of the second sub-plastic deformation layer; and
the stress-strain curve of the fourth sub-plastic deformation layer is the stress-strain curve of the third sub-plastic deformation layer minus a strengthening curve portion corresponding to a thickness of the third sub-plastic deformation layer.

Optionally, the two-dimensional layered finite element analysis model is formed by contacting five surface elements with an identical length but different heights; wherein,
from bottom to top, the five surface elements correspond to the zeroth sub-plastic deformation layer, the first sub-plastic deformation layer, the second sub-plastic deformation layer, the third sub-plastic deformation layer and the fourth sub-plastic deformation layer in order, and a height ratio of each surface element is equal to a thickness ratio of the corresponding sub-plastic deformation layer; and
the upper edge of the top surface element corresponding to the fourth sub-plastic deformation layer is the micro-topography curve of the machined surface.

A method for analyzing a generalized microscopic stress concentration phenomenon on a machined surface by using the two-dimensional layered finite element analysis model obtained by the aforementioned modeling method, including the following steps:
101: adding mechanical property parameters of the machined specimen to the two-dimensional layered finite element analysis model to obtain a model simulating a surface of the machined specimen;
102: according to a test condition of the machined specimen, applying the test condition to the model simulating the surface of the machined specimen, and calculating to obtain stress distribution information of the model simulating the surface of the machined specimen;
103: obtaining a maximum stress position point and a maximum stress value σₘₐₓ corresponding to the maximum stress position point according to the stress distribution information of the model simulating the surface of the machined specimen; and
104: comparing the stress value corresponding to the maximum stress position point with a theoretical stress value corresponding to the stress-strain curve of the matrix material structure of the specimen to be machined to obtain a generalized microscopic stress concentration factor Kₜ of the machined surface of the machined specimen to be processed.

Optionally, in step 101, the mechanical property parameters include one or more of the following parameters: a density, a Young's modulus and a Poisson's ratio of the matrix material structure of the specimen to be machined, the stress-strain curve of each sub-plastic deformation layer, a size of the model, a loaded strain value ε, and the theoretical stress value σ₀ under the strain condition.

Optionally, in step 102 the test condition is as follows: a displacement constraint in a direction away from the model is applied to both sides of the two-dimensional layered finite element analysis model, wherein the displacement constraint l is obtained by formula 1;

$$l = \frac{ɛ \cdot L}{2} ; \qquad formula 1$$

wherein, ε is a loaded strain value; L is a length of the two-dimensional layered finite element analysis model, a unit of L is millimeter.

Optionally, in step 104, the generalized microscopic stress concentration factor Kₜ of the machined surface is obtained by formula 2;

Kₜ=σₘₐₓ/σ₀; formula 2
wherein, σₘₐₓ is the stress value corresponding to the maximum stress position point of the analysis model, and σ₀ is the theoretical stress value of the matrix material structure, and units of both σₘₐₓ and σ₀ are MPa.

### (3) Advantages

The advantages of the present invention are as follows. In the first aspect, the method of the present invention synthesizes the stress concentration phenomenon produced by the microscopic geometric morphology of the surface and the stress concentration phenomenon formed by the plastic strengthening of the surface, so as to form a mechanism analysis model of the influence that the generalized microscopic stress concentration phenomenon of the machined surface has on the fatigue performance of the specimen, which makes up for the deficiency of using the geometric microscopic stress concentration phenomenon in the research.

In the second aspect, the method for analyzing the generalized microscopic stress concentration phenomenon on the machined surface adopts the two-dimensional layered finite element analysis model to achieve the comprehensive analysis of the rule on how the important indexes of the surface integrity affect the fatigue performance of the specimen, which reasonably reveals the mechanism of the influence that the surface integrity has on the fatigue performance of the specimen and provides significant guidance for studying the mechanism of the influence that the machined surface integrity has on the fatigue performance of the specimen.

### BRIEF DESCRIPTION OF THE DRAWINGS

FIG. 1 shows a formation mechanism of the strengthening microscopic stress concentration phenomenon.

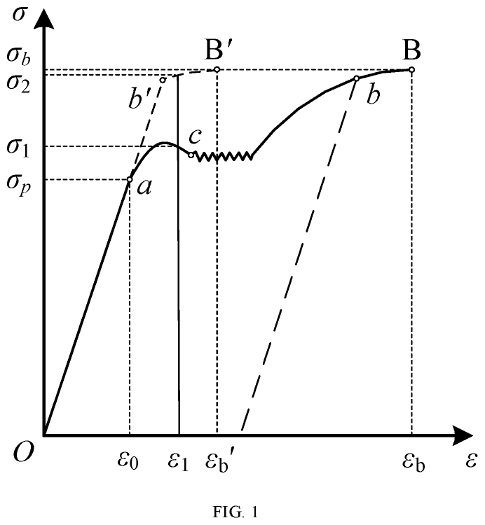

FIG. 2 is a flow chart of a method for modeling a generalized microscopic stress concentration phenomenon on a machined surface according to Embodiment 1 of the present invention.

FIG. 3 is a flow chart of a method for analyzing a generalized microscopic stress concentration phenomenon on a machined surface according to Embodiment 2 of the present invention.

FIG. 4 is a schematic diagram of a two-dimensional layered finite element model according to Embodiment 3 of the present invention.

FIG. 5 is a schematic diagram showing the layering of the plastic deformation layers of the machined surface according to Embodiment 3 of the present invention.

FIG. 6 is a schematic diagram showing the segmentation of the stress-strain curve of each sub-plastic deformation layer according to Embodiment 3 of the present invention.

### DETAILED DESCRIPTION OF THE EMBODIMENTS

In order to clearly illustrate the present invention and facilitate its understanding, the invention is described in detail in combination with the drawings and through specific embodiments.

### Embodiment 1

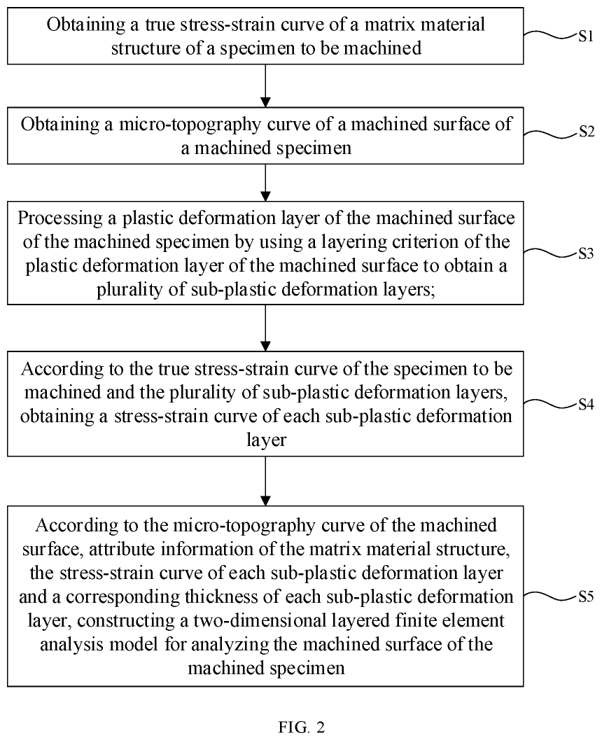

The present embodiment provides a method for modeling the generalized microscopic stress concentration phenomenon on the machined surface. The present embodiment is mainly executed by a computer. Understandably, a curve can be obtained in advance through a normal tensile test and input/transmitted to the computer. As shown in FIG. 2, the modeling method includes the following steps.

S1: a true stress-strain curve of a matrix material structure of a specimen to be machined is obtained.

S2: a micro-topography curve of a machined surface of a machined specimen is obtained, wherein the machined specimen is obtained after the specimen to be machined is machined in advance. For example, the specimen to be machined is machined by using the corresponding technological methods and parameters in advance to obtain the machined specimen.

S3: a plastic deformation layer of a surface of the machined specimen is processed by using the layering criterion of the plastic deformation layer of the machined surface to obtain a plurality of sub-plastic deformation layers.

Preferably, before step S3, the identification method of the plastic deformation layer is adopted to identify the plastic deformation layer of the surface of the machined specimen, wherein the identification method includes the following steps:
the fibrous deformation and direction of the grains in the cross-section structure of the machined specimen are observed, and the total thickness of the plastic fiber-like structure produced by the material metallographic structure of the machined specimen in the direction perpendicular to the machined surface is determined according to the fibrous deformation and direction, as to determine the plastic deformation layer of the machined surface. In the specific implementation process, it is necessary to determine the influence depth of the machining on the surface plastic deformation, that is, the total thickness of the plastic fiber-like structure produced by the material metallographic structure in the direction perpendicular to the machined surface.

For example, starting from the boundary between the matrix material structure and the plastic deformation, the plastic deformation layer is divided into a plurality of sub-plastic deformation layers according to the angle θ between the fibrous direction of the grains in the material structure and the normal direction of the machined surface.

For example, the plurality of sub-plastic deformation layers include: a zeroth sub-plastic deformation layer, a first sub-plastic deformation layer, a second sub-plastic deformation layer, a third sub-plastic deformation layer and a fourth sub-plastic deformation layer; and
wherein, the angle θ of the zeroth sub-plastic deformation layer is equal to 0 degrees, the angle θ of the first sub-plastic deformation layer is greater than 0 degrees and less than or equal to 30 degrees, the angle θ of the second sub-plastic deformation layer is greater than 30 degrees and less than or equal to 60 degrees, the angle θ of the third sub-plastic deformation layer is greater than 60 degrees and less than 75 degrees, and the angle θ of the fourth sub-plastic deformation layer is greater than 75 degrees and less than or equal to 90 degrees.

S4: according to the true stress-strain curve of the specimen to be machined and the plurality of sub-plastic deformation layers, a stress-strain curve of each sub-plastic deformation layer is obtained.

Preferably, in step S4, the stress-strain curve of each sub-plastic deformation layer is obtained, wherein
the stress-strain curve of the zeroth sub-plastic deformation layer is the same as the true stress-strain curve of the matrix material structure;
based on the thicknesses ratio of the sub-plastic deformation layers other than the zeroth sub-plastic deformation layer, the plastic deformation strengthening portion of the true stress-strain curve is segmented in equal proportion on the coordinate axis of the strain variable, so as to obtain a stress-strain curve of the first sub-plastic deformation layer, a stress-strain curve of the second sub-plastic deformation layer, a stress-strain curve of the third sub-plastic deformation layer and a stress-strain curve of the fourth sub-plastic deformation layer, respectively;
wherein, the stress-strain curve of the first sub-plastic deformation layer is the stress-strain curve of the zeroth sub-plastic deformation layer minus the yield portion of the matrix material structure;
the stress-strain curve of the second sub-plastic deformation layer is the stress-strain curve of the first sub-plastic deformation layer minus the strengthening curve portion corresponding to the thickness of the first sub-plastic deformation layer;
the stress-strain curve of the third sub-plastic deformation layer is the stress-strain curve of the second sub-plastic deformation layer minus the strengthening curve portion corresponding to the thickness of the second sub-plastic deformation layer; and
the stress-strain curve of the fourth sub-plastic deformation layer is the stress-strain curve of the third sub-plastic deformation layer minus the strengthening curve portion corresponding to the thickness of the third sub-plastic deformation layer.

S5: according to the micro-topography curve of the machined surface of the machined specimen, the attribute information of the matrix material structure, the stress-strain curve of each sub-plastic deformation layer and the corresponding thickness of each sub-plastic deformation layer, a two-dimensional layered finite element analysis model is constructed for the analysis of the machined surface of the machined specimen.

Preferably, the two-dimensional layered finite element analysis model is formed by contacting five surface elements with the same length but different heights.

From bottom to top, the five surface elements correspond to the zeroth sub-plastic deformation layer, the first sub-plastic deformation layer, the second sub-plastic deformation layer, the third sub-plastic deformation layer and the fourth sub-plastic deformation layer in order, and the height ratio of each surface element is equal to the thickness ratio of the corresponding sub-plastic deformation layer.

The upper edge of the top surface element corresponding to the fourth sub-plastic deformation layer is the micro-topography curve of the machined surface.

### Embodiment 2

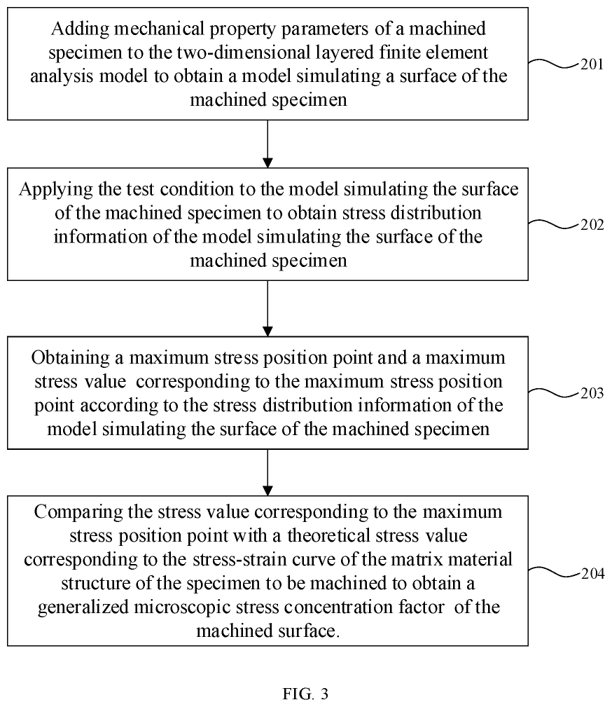

The present embodiment provides a method for analyzing the generalized microscopic stress concentration phenomenon on the machined surface, that is, analyzing the two-dimensional layered finite element analysis model obtained by the method in embodiment 1. As shown in FIG. 3, the analysis method includes the following steps:

Step 201: the mechanical property parameters of the machined specimen are added to the two-dimensional layered finite element analysis model to obtain a model simulating the surface of the machined specimen.

Preferably, in step 201, the mechanical property parameters include one or more of the following parameters: the density, the Young's modulus and the Poisson's ratio of the matrix material structure of the specimen to be machined, the stress-strain curve of each sub-plastic deformation layer, the size of the model, the loaded strain value ε, and the theoretical stress value σ₀ under the strain condition. In the specific implementation process, according to the analysis requirements and the initial conditions, the required parameters and load conditions of the model simulating the machined surface of the specimen are determined.

For example, the test condition in the present embodiment is as follows: a displacement constraint in a direction away from the model is applied to both sides of the two-dimensional layered finite element analysis model, wherein the displacement constraint l is calculated by formula 1;

$$l = \frac{ɛ \cdot L}{2} ; \qquad formula 1$$

wherein, ε is a loaded strain value; L is the length of the two-dimensional layered finite element analysis model, the unit of L is millimeter.

Step 202: according to the test condition of the machined specimen, the test condition is applied to the model simulating the surface of the machined specimen, and the stress distribution information of the model simulating the surface of the machined specimen is obtained through calculation.

Step 203: the maximum stress position point and the stress value σₘₐₓ corresponding to the maximum stress position point are obtained according to the stress distribution information of the model simulating the surface of the machined specimen.

Step 204: the stress value corresponding to the maximum stress position point is compared with the theoretical stress value corresponding to the stress-strain curve of the matrix material structure of the specimen to be machined, the generalized microscopic stress concentration factor Kₜ of the machined surface of the specimen to be machined is obtained.

Preferably, the generalized microscopic stress concentration factor Kₜ of the machined surface is obtained by formula 2;

Kₜ=σₘₐₓ/σ₀; formula 2
wherein, σₘₐₓ is the stress value corresponding to the maximum stress position point of the analysis model, and σ₀ is the theoretical stress value of the matrix material structure, and the units of both σₘₐₓ and σ₀ are MPa.

### Embodiment 3

A Ti-6Al-4V titanium alloy (hereinafter, referred to as TC4 titanium alloy) is taken as the specimen to be machined in the present embodiment specifically, the steps of constructing a two-dimensional layered finite element analysis model for analyzing the machined specimen made of the TC4 titanium alloy includes:

301: the test material is the TC4 titanium alloy, and the true stress-strain curve of the TC4 titanium alloy is obtained by using the normal tensile test.

302: under the conditions of a cutting speed of 20 m/min, a feed rate of 0.08 mm/r and a cutting depth of 0.1 mm, the TC4 titanium alloy is machined in the turning process to obtain the machined specimen of the TC4 titanium alloy, and then the micro-topography curve of the surface of the machined specimen of the TC4 titanium alloy is measured.

303: the plastic deformation degree and the influence depth of the cross-section metallographic structure of the machined specimen are observed after the turning; starting from the boundary between the matrix material structure and the plastic deformation of the structure, the plastic deformation layer is quantitatively layered to obtain five sub-plastic deformation layers according to the angle θ between the fibrous direction of the grains in the material structure and the normal direction of the machined surface.

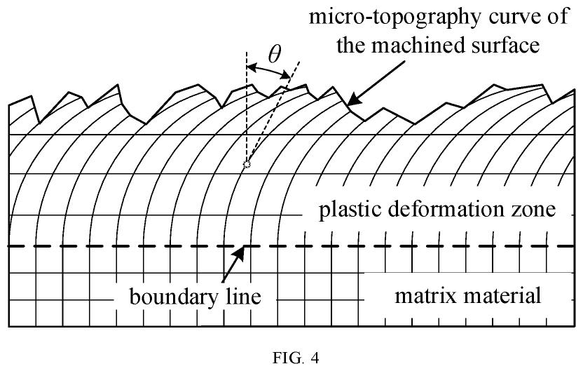

As shown in FIG. 4, the plastic deformation layer of 6=0°, i.e. the matrix material layer, is regarded as the zeroth sub-plastic deformation layer; the plastic deformation layer of 0°<θ≤30° is regarded as the first sub-plastic deformation layer; the plastic deformation layer of 30°<θ≤60° is regarded as the second sub-plastic deformation layer; the plastic deformation layer of 60°<θ≤75° is regarded as the third sub-plastic deformation layer; and the plastic deformation layer of 75°<θ≤90° is regarded as the fourth sub-plastic deformation layer.

After measuring, the thickness of the zeroth plastic deformation layer is 50 μm, and the thicknesses of the first plastic deformation layer to the fourth plastic deformation layer are 1 μm, 2 μm, 5 μm and 10 μm, respectively.

304: based on the true stress-strain curve of the TC4 titanium alloy, according to the quantitatively layered thickness ratio of 1:2:5:10 of the first sub-plastic deformation layer to the second sub-plastic deformation layer to the third sub-plastic deformation layer and to the fourth sub-plastic deformation layer, the plastic deformation strengthening portion of the true stress-strain curve of the test matrix material is segmented in equal proportion on the coordinate axis of the strain variable.

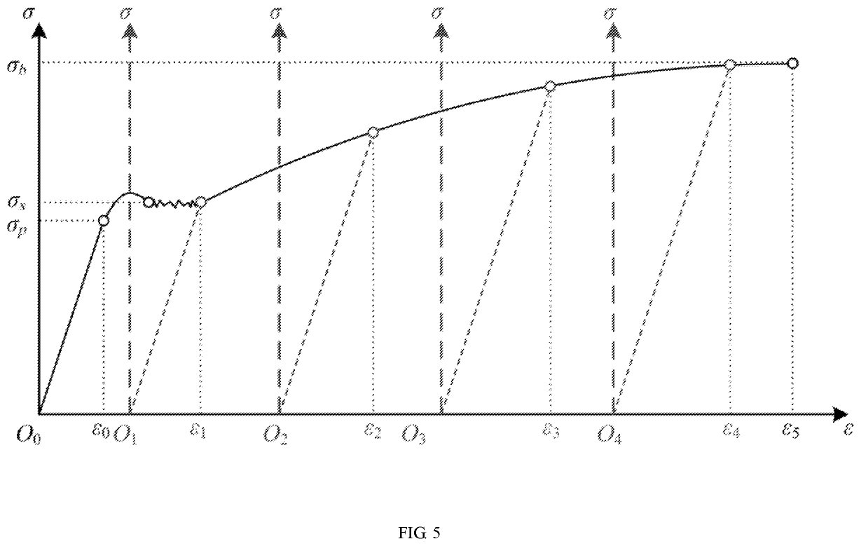

As shown in FIG. 5, the zeroth sub-plastic deformation layer, that is, the matrix material, maintains the original true stress-true strain curve; the stress-strain curve of the first sub-plastic deformation layer material is the original true stress-strain curve minus the yield portion of the material; the stress-strain curve of the second sub-plastic deformation layer material is the true stress-strain curve minus the strengthening curve portion corresponding to the thickness of the first sub-plastic deformation layer. By analogy, the stress-strain curves of the third and fourth sub-plastic deformation layers are obtained.

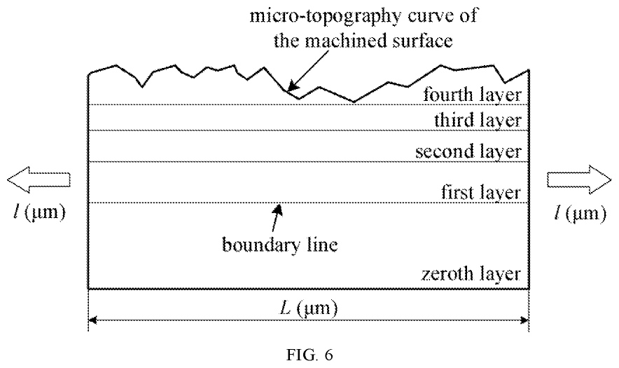

305: a two-dimensional layered finite element analysis model is established, wherein the two-dimensional layered finite element analysis model includes the micro-topography curve of the machined surface, the plastic deformation layer of the surface, and the matrix material structure. As shown in FIG. 6, the mechanical property parameters are added to the two-dimensional layered finite element analysis model.

The required parameters and load conditions of the simulation model in the present embodiment are as follows: the TC4 titanium alloy has the density of 4.43 g/cm³, the Young's modulus of 110 GPa and the Poisson's ratio of 0.34, the thickness of the zeroth sub-plastic deformation layer is 50 μm, the length of the model is 2000 μm, the strain value F to be loaded is 0.02, and the theoretical stress value is 825 MPa under this strain condition.

Further, the two-dimensional layered finite element analysis model based on step 305 is analyzed by the following steps:

306: the model is subdivided into meshes, and the displacement constraint with the length l of 20 μm in the direction far away from the model is loaded on both sides of the model, and proceed to solve and calculate the model.

307: the maximum stress position point is located on the machined surface and the maximum stress σₘₐₓ=1039.7 MPa.

308: the generalized microscopic stress concentration factor of the machined surface of the TC4 titanium alloy is calculated as Kₜ=σₘₐₓ/σ₀=1.26.

Finally, it should be noted that the above embodiments are only used to illustrate the technical solution of the present invention rather than limit the same. Although the present invention is described in detail with reference to the aforementioned embodiments, those skilled in the art should understand that they can still make the modification of the technical solution recorded in the aforementioned embodiments, or equivalent replacements of some or all of the technical features in the aforementioned embodiments. These modifications or replacements do not deviate from the essence nor from the scope of the technical solution of the embodiments of the present invention.

1. A method for modeling a generalized microscopic stress concentration phenomenon on a machined surface, comprising the following steps:
S1: obtaining a true stress-strain curve of a matrix material structure of a specimen to be machined;
S2: obtaining a micro-topography curve of a machined surface of a machined specimen, wherein the machined specimen is obtained after the specimen to be machined is machined in advance;
S3: processing a plastic deformation layer of the machined surface of the machined specimen by using a layering criterion of the plastic deformation layer of the machined surface to obtain a plurality of sub-plastic deformation layers;
S4: according to the true stress-strain curve of the specimen to be machined and the plurality of sub-plastic deformation layers, obtaining a stress-strain curve of each sub-plastic deformation layer of the plurality of sub-plastic deformation layers; and
S5: according to the micro-topography curve of the machined surface of the machined specimen, attribute information of the matrix material structure, the stress-strain curve of each sub-plastic deformation layer and a thickness of each sub-plastic deformation layer, constructing a two-dimensional layered finite element analysis model for analyzing the machined surface of the machined specimen, wherein the thickness of each sub-plastic deformation layer corresponds the stress-strain curve of each sub-plastic deformation layer.

2. The method of claim 1, wherein, before step S3, an identification method of the plastic deformation layer is adopted to identify the plastic deformation layer of the machined surface of the machined specimen, wherein the identification method comprises the following steps:
observing a fibrous deformation of grains and a fibrous direction of the grains in a cross-section of the plastic deformation layer of the machined surface, and determining a total thickness of a plastic fiber-like structure produced by a material metallographic structure of the machined specimen in a direction perpendicular to the machined surface according to the fibrous deformation and the fibrous direction to determine the plastic deformation layer of the machined surface; and
dividing the plastic deformation layer of the machined surface into the plurality of sub-plastic deformation layers according to an angle θ between the fibrous direction of the grains in the cross-section of the plastic deformation layer and a normal direction of the machined surface.

3. The method of claim 2, wherein, the plurality of sub-plastic deformation layers comprise: a zeroth sub-plastic deformation layer, a first sub-plastic deformation layer, a second sub-plastic deformation layer, a third sub-plastic deformation layer and a fourth sub-plastic deformation layer; and
wherein, an angle θ of the zeroth sub-plastic deformation layer is equal to 0 degrees, an angle θ of the first sub-plastic deformation layer is greater than 0 degrees and less than or equal to 30 degrees, an angle θ of the second sub-plastic deformation layer is greater than 30 degrees and less than or equal to 60 degrees, an angle θ of the third sub-plastic deformation layer is greater than 60 degrees and less than 75 degrees, and an angle θ of the fourth sub-plastic deformation layer is greater than 75 degrees and less than or equal to 90 degrees.

4. The method of claim 3, wherein, in step S4, the stress-strain curve of each sub-plastic deformation layer is obtained, wherein
a stress-strain curve of the zeroth sub-plastic deformation layer is identical to the true stress-strain curve of the matrix material structure;
based on a thicknesses ratio of the first sub-plastic deformation layer to the second sub-plastic deformation layer to the third sub-plastic deformation layer and to the fourth sub-plastic deformation layer, a plastic deformation strengthening portion of the true stress-strain curve is segmented in equal proportion on a coordinate axis of a strain variable to obtain a stress-strain curve of the first sub-plastic deformation layer, a stress-strain curve of the second sub-plastic deformation layer, a stress-strain curve of the third sub-plastic deformation layer and a stress-strain curve of the fourth sub-plastic deformation layer, respectively;
wherein, the stress-strain curve of the first sub-plastic deformation layer is the stress-strain curve of the zeroth sub-plastic deformation layer minus a yield portion of the matrix material structure;
the stress-strain curve of the second sub-plastic deformation layer is the stress-strain curve of the first sub-plastic deformation layer minus a strengthening curve portion corresponding to a thickness of the first sub-plastic deformation layer;
the stress-strain curve of the third sub-plastic deformation layer is the stress-strain curve of the second sub-plastic deformation layer minus a strengthening curve portion corresponding to a thickness of the second sub-plastic deformation layer; and
the stress-strain curve of the fourth sub-plastic deformation layer is the stress-strain curve of the third sub-plastic deformation layer minus a strengthening curve portion corresponding to a thickness of the third sub-plastic deformation layer.

5. The method of claim 4, wherein, the two-dimensional layered finite element analysis model is formed by contacting five surface elements, and the five surface elements have an identical length but different heights;
from bottom to top, the five surface elements correspond to the zeroth sub-plastic deformation layer, the first sub-plastic deformation layer, the second sub-plastic deformation layer, the third sub-plastic deformation layer and the fourth sub-plastic deformation layer in order, and a height ratio of the five surface elements is equal to a thickness ratio of the plurality of sub-plastic deformation layers respectively corresponding to the five surface elements; and
an upper edge of a top surface element of the five surface elements corresponding to the fourth sub-plastic deformation layer is the micro-topography curve of the machined surface.

6. A method for analyzing a generalized microscopic stress concentration phenomenon on a machined surface by using the two-dimensional layered finite element analysis model of claim 1, comprising the following steps:
101: adding mechanical property parameters of the machined specimen to the two-dimensional layered finite element analysis model to obtain a model simulating a surface of the machined specimen;
102: according to a test condition of the machined specimen, applying the test condition to the model simulating the surface of the machined specimen, and calculating to obtain stress distribution information of the model simulating the surface of the machined specimen;
103: obtaining a maximum stress position point and a stress value σₘₐₓ corresponding to the maximum stress position point according to the stress distribution information of the model simulating the surface of the machined specimen; and
104: comparing the stress value corresponding to the maximum stress position point with a theoretical stress value corresponding to the stress-strain curve of the matrix material structure of the specimen to be machined to obtain a generalized microscopic stress concentration factor Kₜ of the machined surface to be processed.

7. The method of claim 6, wherein, in step 101, the mechanical property parameters comprise the following parameters: a density, a Young's modulus and a Poisson's ratio of the matrix material structure of the specimen to be machined, the stress-strain curve of each sub-plastic deformation layer, a size of the model, a loaded strain value ε, and the theoretical stress value σ₀ corresponding to the loaded strain value ε.

8. The method of claim 6, wherein, in step 102, the test condition is as follows: a displacement constraint in a direction away from the model is applied to both sides of the two-dimensional layered finite element analysis model, wherein the displacement constraint l is obtained by formula 1;
$$l = \frac{ɛ \cdot L}{2} ; \qquad formula 1$$
where, ε is a loaded strain value; L is a length of the two-dimensional layered finite element analysis model, a unit of L is millimeter.

9. The method of claim 6, wherein, in step 104, the generalized microscopic stress concentration factor Kₜ of the machined surface is obtained by formula 2;
Kₜ=σₘₐₓ/σ₀; formula 2
where, σₘₐₓ is the stress value corresponding to the maximum stress position point of the two-dimensional layered finite element analysis model, and σ₀ is the theoretical stress value of the matrix material structure, and units of both σₘₐₓ and σ₀ are MPa.

10. The method of claim 6, wherein, before step S3, an identification method of the plastic deformation layer is adopted to identify the plastic deformation layer of the machined surface of the machined specimen, wherein the identification method comprises the following steps:
observing a fibrous deformation of grains and a fibrous direction of the grains in a cross-section of the surface material structure of the machined specimen, and determining a total thickness of a plastic fiber-like structure produced by a material metallographic structure of the machined specimen in a direction perpendicular to the machined surface according to the fibrous deformation and the fibrous direction to determine the plastic deformation layer of the machined surface; and
dividing the plastic deformation layer of the machined surface into the plurality of sub-plastic deformation layers according to an angle θ between the fibrous direction of the grains in the cross-section of the surface material structure and a normal direction of the machined surface.

11. The method of claim 10, wherein, the plurality of sub-plastic deformation layers comprise: a zeroth sub-plastic deformation layer, a first sub-plastic deformation layer, a second sub-plastic deformation layer, a third sub-plastic deformation layer and a fourth sub-plastic deformation layer; and
wherein, an angle θ of the zeroth sub-plastic deformation layer is equal to 0 degrees, an angle θ of the first sub-plastic deformation layer is greater than 0 degrees and less than or equal to 30 degrees, an angle θ of the second sub-plastic deformation layer is greater than 30 degrees and less than or equal to 60 degrees, an angle θ of the third sub-plastic deformation layer is greater than 60 degrees and less than 75 degrees, and an angle θ of the fourth sub-plastic deformation layer is greater than 75 degrees and less than or equal to 90 degrees.

12. The method of claim 11, wherein, in step S4, the stress-strain curve of each sub-plastic deformation layer is obtained, wherein
a stress-strain curve of the zeroth sub-plastic deformation layer is identical to the true stress-strain curve of the matrix material structure;
based on a thicknesses ratio of the first sub-plastic deformation layer to the second sub-plastic deformation layer to the third sub-plastic deformation layer and to the fourth sub-plastic deformation layer, a plastic deformation strengthening portion of the true stress-strain curve is segmented in equal proportion on a coordinate axis of a strain variable to obtain a stress-strain curve of the first sub-plastic deformation layer, a stress-strain curve of the second sub-plastic deformation layer, a stress-strain curve of the third sub-plastic deformation layer and a stress-strain curve of the fourth sub-plastic deformation layer, respectively;
wherein, the stress-strain curve of the first sub-plastic deformation layer is the stress-strain curve of the zeroth sub-plastic deformation layer minus a yield portion of the matrix material structure;
the stress-strain curve of the second sub-plastic deformation layer is the stress-strain curve of the first sub-plastic deformation layer minus a strengthening curve portion corresponding to a thickness of the first sub-plastic deformation layer;
the stress-strain curve of the third sub-plastic deformation layer is the stress-strain curve of the second sub-plastic deformation layer minus a strengthening curve portion corresponding to a thickness of the second sub-plastic deformation layer; and
the stress-strain curve of the fourth sub-plastic deformation layer is the stress-strain curve of the third sub-plastic deformation layer minus a strengthening curve portion corresponding to a thickness of the third sub-plastic deformation layer.

13. The method of claim 12, wherein, the two-dimensional layered finite element analysis model is formed by contacting five surface elements, and the five surface elements have an identical length but different heights;
from bottom to top, the five surface elements correspond to the zeroth sub-plastic deformation layer, the first sub-plastic deformation layer, the second sub-plastic deformation layer, the third sub-plastic deformation layer and the fourth sub-plastic deformation layer in order, and a height ratio of the five surface elements is equal to a thickness ratio of the plurality of sub-plastic deformation layers respectively corresponding to the five surface elements; and
an upper edge of a top surface element of the five surface elements corresponding to the fourth sub-plastic deformation layer is the micro-topography curve of the machined surface.
